(19) United States
(12) Patent Application Publication
(10) Pub. No.: US 2025/0214222 A1
(43) Pub. Date: Jul. 3, 2025

(54) MAGNETIZED TOOL COVER SLEEVE

(71) Applicants: Cole D. Davis, Milton, WI (US); Lance K. Rice, Milton, WI (US)

(72) Inventors: Cole D. Davis, Milton, WI (US); Lance K. Rice, Milton, WI (US)

(21) Appl. No.: 18/397,235

(22) Filed: Dec. 27, 2023

(51) Int. Cl. B25G 1/10; F16B 1/00; H01F 7/02

(52) U.S. Cl. CPC B25G 1/10; F16B 1/00; F16B 2200/83; H01F 7/02

(57) ABSTRACT

A tool cover sleeve that can be non-removably integrated or removably attached to attach various tools that includes magnets inside of its cavity to magnetically attract objects to the tool with the sleeve on it. The sleeve is a uniform sleeve that includes a narrower top end and a wider lower end and has room to hold one or more magnets. One or more neodymium magnets can be included or stacked over each other inside of the sleeve to attract other objects to the tool, such as a hammer or other tool, to attract nearby nails or other tools that include metal and can form a magnetic attraction to the one or more magnets held within the removable tool cover sleeve.

### FIELD OF THE DISCLOSURE

The present invention relates to a magnetized sleeve that is attachable to an end of a tool in order to allow the tool to easily attract items around the tool that are magnetically attractable. In one embodiment, the magnetized sleeve is non-removably attached to the end of the tool. In another embodiment, the magnetized sleeve is removable and is removably attached to the end of the tool.

### BACKGROUND

Construction work and various other fields and specialties required a great deal of physical labor and intensity. The repetitive nature of having to bend down and raise up and then climb up or down ladders or other devices and to stand for a long period of time can cause injuries in workers, fatigue, and a myriad of other issues.

### SUMMARY

The present description includes one or more non-limiting embodiments for a system for either a non-removable tool cover or a removable tool cover sleeve configured to removably slip or slide over a lower portion of a tool. A system for a tool cover sleeve comprising a tool cover sleeve comprising a body having a uniform, single sleeve with an open upper end, wherein the open upper end defines an interior cavity that extends therethrough to a closed lower end. The tool cover sleeve includes one or more magnets, wherein the one or more magnets fit inside of the tool cover sleeve over the closed lower end of the tool cover sleeve, wherein the tool cover sleeve is non-removably attached to a hammer, wherein the tool cover sleeve covers a lower half of a hammer with the one or more magnets positioned inside of the tool cover sleeve over a bottom interior surface of the closed lower end of the tool cover sleeve.

In one embodiment, the present description includes one or more embodiments for the removable tool cover sleeve comprises a body having a uniform, single sleeve with an open upper end, wherein the open upper end defines an interior cavity that extends therethrough to a closed lower end. One or more magnets fit inside of the removable tool cover sleeve over the closed lower end of the removable tool cover sleeve. In a non-limiting embodiment, the one or more magnets are neodymium magnets. Further, the one or more magnets are stackable over each other within the interior cavity of the removable tool cover sleeve. The body of the removable tool cover sleeve is generally cylindrical and covers at least a portion of the tool. In some embodiments, the removable tool cover sleeve may cover almost an entirety of the handle of the tool. In a non-limiting embodiment, the closed lower end of the removable tool cover sleeve is wider than a width of the open upper end. In a non-limiting embodiment, the tool may be, without limitation thereto, a hammer, a drill, or a screwdriver.

In another aspect, the present description includes one or more non-limiting embodiments for providing a removable tool cover sleeve, the removable tool cover sleeve comprising a body having a uniform sleeve with an open upper end, wherein the open upper end defines an interior cavity that extends therethrough to a closed lower end, and one or more magnets, wherein the one or more magnets fit inside of the removable tool cover sleeve over the closed lower end of the removable tool cover sleeve. The method may further include sliding and/or otherwise attaching the removable sleeve over a lower end or base of a tool so that the removable tool cover sleeve fits snugly over the lower end or base of the tool, bringing the tool having the removable tool cover sleeve covering the lower end or base of the tool to an object capable of magnetic attraction to form a magnetic connection between the object and the removable tool cover sleeve, pulling the object away from the removable tool cover sleeve and utilize the object if needed along with the tool. Upon termination of use, the method may further include removing the removable tool cover sleeve from the tool by sliding the removable tool cover sleeve and embedded one or more magnets off of the tool. The method may further include sliding the removable tool cover sleeve and sliding the removable tool cover sleeve onto another tool. The method may further include stacking at least two magnets of the one or more magnets within the interior cavity of the removable tool cover sleeve.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a block diagram of one or more components related to a system for a magnetized tool sleeve cover.

FIG. 2A is an exemplary pictorial illustration of a non-removable magnetized tool sleeve cover.

FIG. 2B is an exemplary pictorial illustration of a removable magnetized tool cover sleeve.

FIG. 3A is an exemplary pictorial illustration of a magnet for use with a tool sleeve cover.

FIG. 3B is an exemplary pictorial illustration with a cross-sectional view of a tool sleeve cover.

FIG. 4 is a pictorial illustration of a hammer with a tool sleeve cover shown able to magnetically attract a weight.

FIG. 5 is a pictorial illustration of a hammer with a removable tool sleeve cover shown able to magnetically attract a weight.

FIG. 6 is a pictorial illustration of a hammer with a removable tool sleeve cover shown able to magnetically attract a number of objects to the lower end of the removable tool sleeve cover.

FIG. 7 is a flowchart showing an exemplary method of using the removable tool sleeve cover.

FIG. 8 is a flowchart showing an exemplary method using a non-removable tool cover sleeve.

### DETAILED DESCRIPTION

The present description includes exemplary embodiments for a non-removable and a removable tool sleeve cover that is advantageously able to magnetically attract other objects/items to the lower end of the non-removable or removable tool sleeve cover so that the user does not always have to bend over and separately pick up such items that may be hard to grab or whereby it may be physically taxing to repeatedly bend over and pick up the items. In a non-limiting embodiment, the user can use the combination of the tool cover sleeve having the embedded magnets to magnetically attract one or more magnetically attractable objects from a floor surface or another surface (e.g., table, wall, bag, box, any type of container or surface) towards the lower outside end of the tool cover sleeve as fitted over the tool which makes easier for the user to remove the magnetically attracted objects/items by pulling the objects off of the tool cover sleeve rather than having to bend over and pick the objects up individually.

In a non-limiting embodiment, the non-removable or the removable tool sleeve cover has a sleeve that may be made of flexible, but tight fitting material that can fit around the handle of a tool. Inside of the tool sleeve cover are one or more magnets that provide the magnetic attraction/force to attract objects that are capable of being magnetically attracted to the tool sleeve cover containing the magnets. The tool may be for example, and without limitation, a hammer, a drill, a screwdriver, or another type of tool having a handle that a removable tool sleeve cover can be devised to fit over. Further details about the invention according to one or more non-limiting embodiments are provided with respect to the Figures.

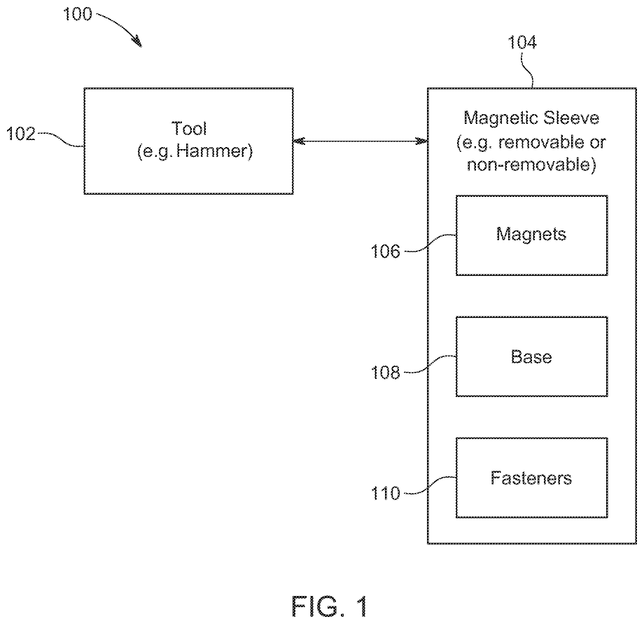

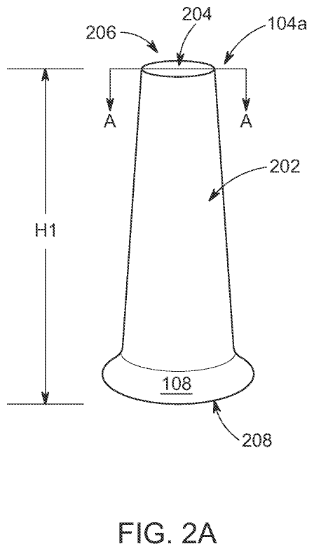

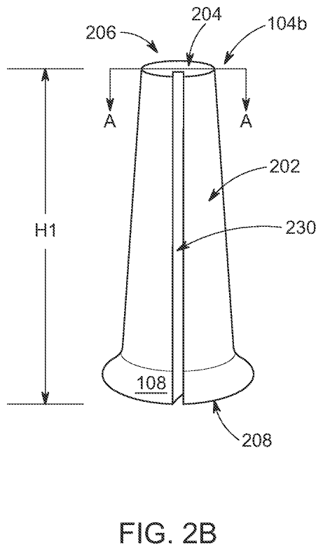

FIG. 1 provides a block diagram of a system 100 for a tool sleeve cover 104. It is noted that in some embodiments, the tool sleeve cover 104 is configured to be non-removable (e.g., as shown in FIG. 2A) and more fixedly attached or integrated into a base and lower area of a handle area of a tool 102. In other non-limiting embodiments, the tool sleeve cover 104 may be removable. An example of a removable tool sleeve cover 104 is shown in FIG. 2B which has a slit included in the tool sleeve cover 104 that enables the user to put on and take off the removable tool sleeve cover 104 onto a tool 102 depending on the need.

The tool sleeve cover 104 includes one or more magnets 106 within an interior cavity of the tool sleeve cover. The one or more magnets 106 may be held within the tool sleeve cover stacked one over the other or otherwise disposed within the interior cavity of the removable tool sleeve cover in order to attract nearby metal containing objects (e.g., nails or other fasteners or other items) that are capable of magnetic attraction to the removable sleeve 104 or that are magnetically attractable objects even if the objects do not include metal. Rather than being stacked in a vertical arrangement or orientation, the one or more magnets 106 may be arranged positioned next to each other in a horizontal arrangement in a non-limiting embodiment. The tool sleeve cover 104 is designed to be slid or otherwise pulled up over the handle or lower area of the tool 102 in order to apply and/or removably or non-removably attach the tool sleeve cover 104 to the tool 102. As noted above, in a non-limiting embodiment, the tool 102 can be a hammer. Advantageously, for the removable embodiment of the magnetized tool sleeve cover 104, the magnetized tool sleeve cover 104 may be removed from the tool and slid over or applied to the handle or base of another tool. Examples of other tools that may have similar diameters include screwdrivers, drills, or other tools, without limitation thereto. As such, there may be instances where the tool sleeve cover 104 is first worn or positioned on a first type of tool (e.g., hammer) and then removed and slid onto a second type of tool (e.g., a screwdriver or drill or other object) having a similar diameter and other dimensions to the removable magnetized tool sleeve cover 104 as the first type of tool. Advantageously, the user benefits from being able to use the magnets contained within the tool sleeve cover 104 to avoid bending over repeatedly or moving in another uncomfortable way (e.g., twisting, sitting up, reaching) to locate objects that can preferably be attracted via magnetic attraction.

In a non-limiting embodiment, as shown in FIG. 1, the tool sleeve cover 104 may also include fasteners 110 such as hook and loop fasteners (e.g., VELCRO) which is able to be used to secure the removable tool sleeve cover 104 over the handle or lower portion of the tool 102. Other types of fasteners may alternatively or additionally be used as well.

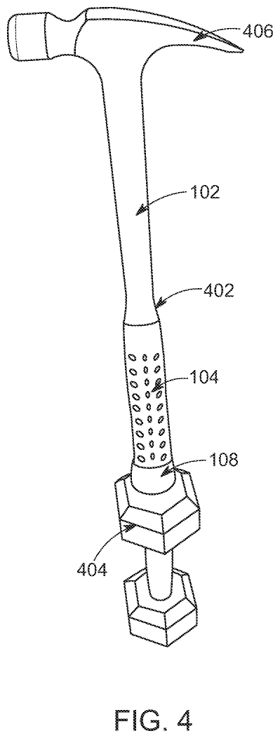

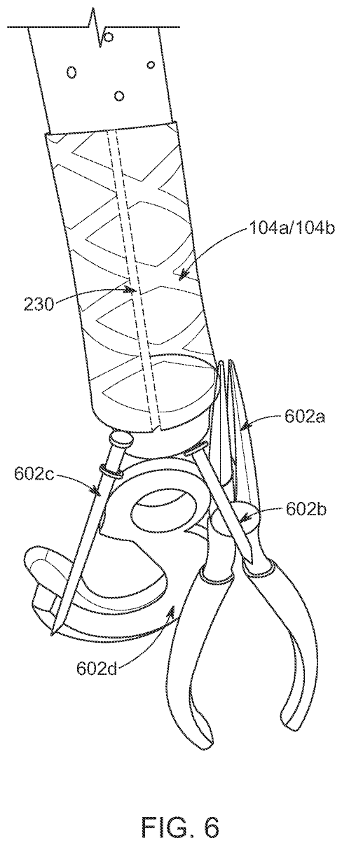

FIG. 2A shows a non-limiting example of a non-removable tool sleeve cover 104a. FIG. 2B shows a non-limiting example of a removable tool sleeve cover 104b because there is a longitudinally oriented slit 230 as shown in FIG. 2B. The slit 230 can be pried open by a user and placed around the lower area or portion of the original handle of a tool 102. The manufacturer, distributor, and/or user has the ability to insert one or more magnets 106 into a base of the removable tool sleeve cover 104b to create a magnetic attraction with one or more magnetically attractable objects (e.g., as shown in FIG. 4 and in FIG. 6) and then is able to fit the removable tool sleeve cover 104b around the tool 102.

The non-removable tool sleeve cover 104a as shown in FIG. 2A and the removable tool sleeve cover as shown in FIG. 2B in a non-limiting embodiment share the same characteristics in many respects except the main difference being that the tool sleeve cover 104b shown in FIG. 2B is intended to be removable so that the user can either add more magnets 106 and/or remove and place on a lower half of another tool 102 other than the original tool 102. This removability is an advantage as it gives the user the ability to use the removable tool sleeve cover 104b on multiple tools and/or add or reduce the number of magnets 106 included within the interior 204 cavity of the removable tool sleeve cover 104b so as to adjust a level of magnetic attraction or strength of magnetic attraction depending on the needs of the user.

It is noted that the non-removable tool sleeve cover 104a also is advantageous even if non-removably positioned or attached to the lower area of the tool 102.

For both the non-removable tool sleeve cover 104a and the removable tool sleeve cover 104b, a pictorial illustration is shown in FIG. 2A and in FIG. 2B. The body 202 of the tool sleeve covers 104a, 104b as shown in FIGS. 2A-2B may include features that are shared or common to both the non-removable 104a and the removable version 104b of the tool sleeve cover 104. The body 202 of the tool sleeve cover 104 includes an open top end 206 that leads to the deep interior cavity 204 of the tool sleeve cover 104. The body further comprises a closed lower end 208 that may also be near or include the base 108 of the tool sleeve cover 104.

In a non-limiting embodiment, the tool sleeve cover 104 is made as a single, integral unit. In a non-limiting embodiment, the tool sleeve cover 104 may be made of materials that allow the tool sleeve cover 104 to be flexible enough to slide over a lower portion of a tool 102, but also tight fitting enough to remain secure over the handle or end of the tool 102. In a non-limiting embodiment, the tool sleeve cover 104 may include or may be made of a type of polyolefin. Polyolefins encompass a family of thermoplastics that include polyethylene and polypropylene. Polyolefins are produced by polymerizing respectively ethylene and propylene, mainly obtained from oil and natural gas but can also be derived from renewable resources (e.g., sugar cane). In another non-limiting embodiment, the tool sleeve cover 104 may be made of plastic or silicone or any other type of material or combination of materials which is flexible and capable of being tight fitting to fit over the handle of the tool 102. In a non-limiting embodiment, the thermoplastic tube that forms the tool sleeve cover 104 is cut to size and then can be heat shrunk onto the handle of the tool 102. This may be particularly useful whether the tool sleeve cover 104 is non-removable 104a or removable 104b. A heating element (e.g., a heat torch or another heating tool) may be used to heat shrink the thermoplastic tube with the integrated magnets 106 onto and over the handle of the tool 106. It is noted that the removable tool sleeve cover 104b may also be made of polyolefin and may be a thermoplastic tube that is cut to specific sizes and lengths and dimensions that the seller or manufacturer or user may select for a tool 106 having a handle or lower area with a corresponding, suitable size such that one can slide on or slip on or otherwise fit the removable tool sleeve cover 104b over the tool 106.

It is noted that in the alternative, the tool sleeve cover 104 may be made of other materials such as but not limited to plastic or a combination of plastic and/or silicone and/or other materials. As noted above, fasteners 110, which may include VELCRO, may be include to help the user keep the tool sleeve cover 104 in place when slid onto the base of the handle of the tool 102.

As shown in FIG. 2A and 2B, the height H1 of the tool sleeve cover 104 is intended to cover at least a lower portion or handle of the tool 102. It is noted that the tool sleeve cover 104 may be designed to have various sizes including diameters, widths, and/or heights (e.g., H1) so as to be able to accommodate different sized tools 102 and their handles.

As shown in FIG. 2A and in FIG. 2B, the tool sleeve cover 104, whether removable 104b or non-removable 104a, may have a narrower width towards a top of the tool sleeve cover 104 and then widen towards the bottom of the tool sleeve cover 104. In other non-limiting embodiments, the tool sleeve cover 104 may become progressively narrower towards the base.

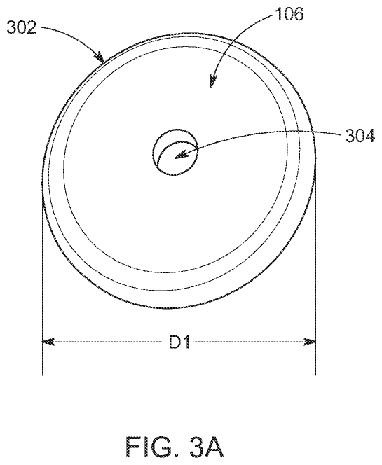

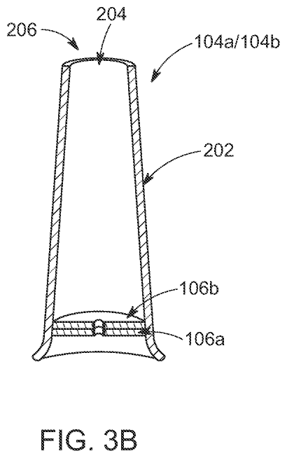

FIG. 3A illustrates an exemplary magnet 106 that may be manually positioned inside of the interior cavity 204 of the tool sleeve cover 104. In a non-limiting embodiment, the magnets 106 are neodymium magnets. A neodymium magnet is a permanent magnet made from an alloy of neodymium, iron, and boron. However, in other non-limiting embodiments, other types of magnets 106 may alternatively be used. The magnet 106 may include a central hole 304 in some non-limiting embodiments. In a non-limiting embodiment, the magnet 106 may be round or circular in shape as shown in FIG. 3A, although other shapes may alternatively be used as well.

The diameter 302 of the magnet 106 may be sized to fit within the interior cavity 204 of the tool sleeve cover 104a, 104b. Accordingly, the open end 206 of the tool sleeve cover 104 is able to be stretched over one or more magnets 106 that fit when pushed down into the base 108 of the tool sleeve cover 104a, 104b. The diameter 306 of the removable magnet 106 may be thus less than the outer diameter of the tool sleeve cover 104a, 104b. Further, in one or more preferred embodiments, the tool sleeve cover 104a, 104b is generally cylindrically shaped as shown in FIG. 2A, FIG. 2B, and in FIG. 3B, although the design of the base 108 of the tool sleeve cover 104a, 104b may vary (e.g., as shown by the various designs of the lower end or base of the tool sleeve cover 104a, 104b as shown in FIG. 4 and in FIG. 6).

FIG. 3B provides a cross-sectional view of the tool sleeve cover 104a, 104b taken along lines A-A as shown in FIG. 2. The pictorial illustration shown in FIG. 3B illustrates that there is a generally hollow interior cavity 204 defined by the body 202 of the tool sleeve cover 104a, 104b including the walls of the tool sleeve cover 104a, 104b. The one or more magnets 106a, 106b are shown stacked over each other near the lower end of the interior cavity 204 of the tool sleeve cover 104a, 104b and near the base 108 of the tool sleeve cover 104. It is noted that it may be sufficient for the user to have one magnet 106 (e.g., magnet 106a) placed within the tool sleeve cover 104. It is an advantage that additional magnets 106b can be added over each magnet in a stacked manner or a side by side manner to increase the pull force of the magnets 106. In a non-limiting embodiment, the magnets 106 may be approximately a 1/4 inch thick. Adding additional magnets 106 over each other helps to increase the pull force of the magnets 106 and allows the magnets 106 when contained within the interior cavity 204 of the tool sleeve cover 104 to pull a greater weight of magnetically attractable objects to the tool sleeve or tool sleeve cover 104. While FIG. 3B shows only two magnets 106a, 106b included within the interior cavity 204 of the tool sleeve cover 104, it is noted that more than this number may be added if so desired by the user or manufacturer of the tool sleeve cover 104.

In a non-limiting embodiment, the closed lower end 208 of the tool sleeve cover 104 (whether non-removable 104a or removable 104b) may not twist off or be removable. Rather, the closed lower end 208 is formed with the remaining material that makes up the tool sleeve cover 104 and is not separately detachable. Thus, in this embodiment, the one or more magnets 106 are dropped or otherwise positioned into the interior cavity 204 of the tool sleeve cover 104 such that the one or more magnets 106 fall to the interior surface of the closed lower end 208 and cannot fall out. The user would then insert the base of the tool 102 (e.g., as shown in FIGS. 4-6) into the interior cavity 204 of the tool sleeve cover 104 so that a bottom end of the tool 102 may touch the one or more inserted magnets 106 and prevent the magnets 106 from too much movement within the interior cavity 204 of the tool sleeve cover 104 due to the positioning of the tool 102 over the magnets 106. As noted above, in one or more non-limiting embodiments, the tool sleeve cover 104 are either heat shrunk to very closely fit around the handle or lower area 402 of the tool 102. Alternatively, the tool sleeve cover 104 is made of material that is snug fitting and an appropriate dimension of a pre-formed tool sleeve cover 104 is selected so as not to be too wide or too small when fitted around or over the handle 402 of the tool 102. In this sense, the tool sleeve cover 102 is intended to be skin tight in its fit on the handle 402 of the tool 102 to prevent excess movement or slippage of the tool sleeve cover 104 on the handle 402 of the tool 102, which would cause a great deal of discomfort to the user of the tool 102.

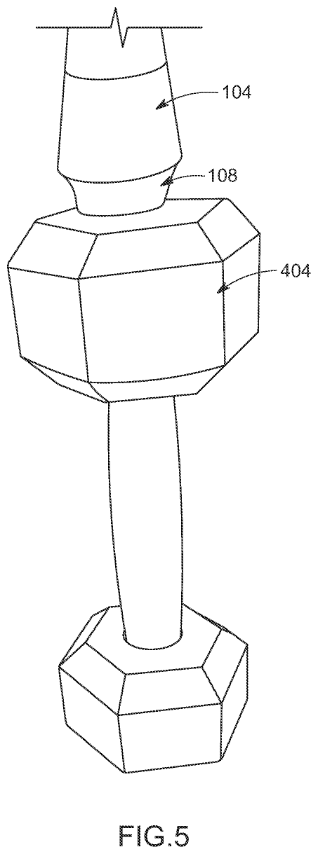

FIGS. 4-5 show an example of a tool sleeve cover 104 attached and positioned over a handle 402 of a tool 102. The exemplary tool 102 shown in FIGS. 4-5 is a hammer as shown in the illustrations. The tool sleeve cover 104 may cover the lower end of the handle 402 of the tool 102 but still allow the upper working end 406 of the tool 102 to be accessed and used according to normal operation of the tool 102. The tool sleeve cover 104 includes a base 108 and the one or more magnets 106 as shown in FIG. 3A and in FIG. 3B are intended to already be positioned or placed inside of the tool sleeve cover 104 prior to sliding the tool sleeve cover 104 over the lower portion or base of the tool 102.

It is noted that the tool sleeve cover 104 may be sold having one or more magnets 106 already positioned therein. Further, additional magnets 106 may be provided in a kit or package containing the tool sleeve cover 104 such that the user is able to add or remove the number of magnets 106 to the interior cavity 204 of the tool sleeve cover 104.

It is noted that in other non-limiting embodiments, the magnets 106 included inside of the interior cavity 204 of the tool sleeve cover 104 may not be removable and may be securely and non-removably installed therein. In such instances, if the sleeve cover 104 is a removable sleeve cover 104b, the removable sleeve 104 can still be slid on and off various tools 102 but the user would not be able to remove the magnets 106 that are permanently and fixedly embedded deep within the interior cavity 204 near the base 108 or lower portion of the tool sleeve 104.

FIG. 5 shows that the base 108 of the tool sleeve cover 104 may be narrower in its width and/or diameter in some cases than an upper portion of the tool sleeve cover 104. Accordingly, the tool sleeve cover 104 may encompass different designs to his outward appearance. For example, the outer surface of the tool sleeve cover 104 may have no lines or patterns or texture. In other instances, the outer surface of the tool sleeve cover 104 may have a design or pattern on its exterior surface as shown in FIG. 4 and in FIG. 6 according to one or more non-limiting embodiments.

FIG. 4 and FIG. 5 are pictorial illustrations that illustrate that the magnets 106 may be able to hold a great deal of force. According to testing, the addition of two magnets 106a, 106b to the interior cavity 204 of the tool sleeve 104 may allow the tool 102 having the tool sleeve cover 104 with the embedded magnets 106 pick up and hold without the use of additional hands or aid of the user about 5-8 pounds of weight in a non-limiting embodiment.

FIG. 6 shows another pictorial illustration of the tool tool sleeve cover 104 slid over and positioned over the lower portion or handle 402 of the tool 102 with the embedded magnets 106 having held a number of magnetically attractable objects such as objects 602a-602d. In a non-limiting embodiment, a slit 230 is formed in the body 202 of the tool sleeve cover 104b as shown in FIG. 2B (in a non-limiting embodiment) and optionally herein in FIG. 6 in the instance where the tool sleeve cover 104 is a removable tool sleeve cover 104b. There may be other means of rendering the tool sleeve cover 104b to be removable including using one or more zippers or other fasteners (e.g., snaps, buttons, or clips) that can be used to fasten the removable tool sleeve cover 104b over the handle 402 of the tool 102 after the removable tool sleeve cover 104b is slid over the handle 402 of the tool 102.

As shown in FIG. 6, in a non-limiting embodiment, the objects include a pair of metal pliers 602a, nails/screws 602b and 602c, and another metal object 602d. These objects 602a-602d are non-limiting embodiments meant to illustrate that the tool sleeve cover 104 has the benefit of allowing the user to bring the tool 102 with the positioned tool sleeve cover 104 close to a number of objects 602 that can on their own be magnetically attracted and held to the lower end or base 108 of the tool sleeve cover 104. Notably, the magnetically attractable objects 602 include all or some amount of metal that allow for a magnetic connection to the magnets 106 embedded or contained within the tool sleeve cover 104. The user can then pull away each object 602 one by one with the user's hands if the user so chooses and thus break the magnetic connection between the one or more objects 602 and the tool sleeve cover 104. Notably, the tool sleeve cover 104 can act as an ergonomic device and aid that minimizes the user having to bend over or squat down to pick up the objects 602 that can be magnetically attracted to the tool sleeve cover 104.

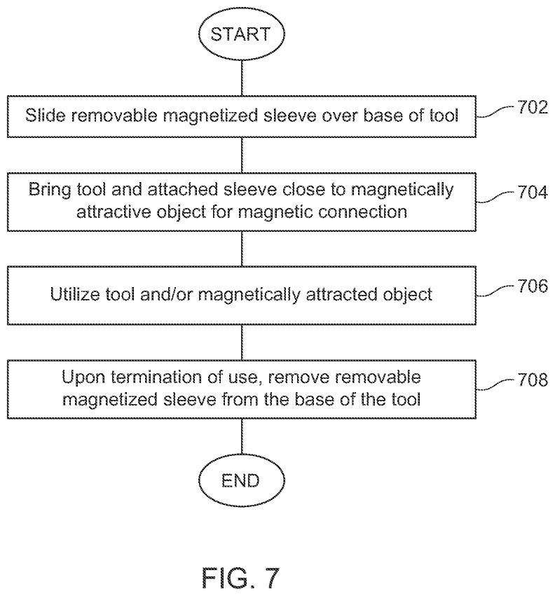

FIG. 7 is a flowchart of an exemplary method of using the removable tool sleeve cover 104b. In a non-limiting embodiment, the method may include at step 702, sliding or otherwise positioning or pulling up the removable magnetized sleeve 104b over a base or lower portion of the handle 402 of the tool 102. At step 704, the method may include bringing the tool 102 and the attached sleeve 104 close to a magnetically attractable object 602 in order to establish a magnetic connection between the removable tool sleeve cover 104b (while the removable tool sleeve cover 104b fits over the lower portion of the tool 102) and the magnetically attractable object 602. At step 706, the method may include utilizing the tool 102 if needed and the user can pull off the one or more magnetically attracted object 602 and use to perform work if needed.

If the user used the sleeve cover 104 to magnetically attract one o more nails, screws, or other magnetically attractable objects as the magnetically attracted object 602, the user can attract the nail to the magnetized tool sleeve cover 104 and then pull the nail off and proceed to hammer the nail into one or more surfaces and continue with the user's work to attract other nails (or other magnetically attractable objects 602) if so desired.

It is noted that it is also possible that the user utilizes the tool sleeve cover 104 to attract metal objects 602 for clearing and cleaning up an area without necessarily needing to utilize the magnetically attractable objects in a job, project, or action.

In a non-limiting embodiment, upon termination of use, as shown at step 708, the removable magnetized sleeve 104b may be removed from the base or handle 402 of the tool 102 and stored or applied to another tool 102 for use. In a non-limiting embodiment, it is envisioned that a user can remove the removable magnetized sleeve 104b from a handle 402 of a hammer, for example, and then slide it or otherwise position it onto the lower end of the handle 402 of a drill or screwdriver or another tool.

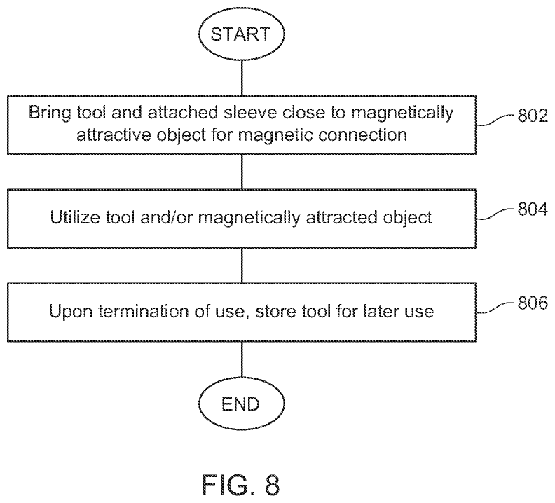

FIG. 8 is a flowchart of an exemplary method of using a non-removable tool sleeve cover 104a. As shown in FIG. 8, in a non-limiting embodiment, the user may bring a tool 102 having an already attached sleeve cover 104a as close as needed to a magnetically attractive or attractable object for purposes of creating a magnetic connection with the object and the sleeve cover 104a as shown at step 802. Next, as shown at step 804, the user may utilize the tool 102 and/or magnetically attracted object. As shown at step 806, upon termination of use, the user may store the tool 102 with the fixed, non-removable tool sleeve cover 104a for later use to magnetically attract other magnetically attractable objects.

As noted above, in a non-limiting embodiment, the non-removable tool sleeve cover 104b acts as a close fitting skin over the lower half or handle 402 of the tool 102. Further, in a non-limiting embodiment, the close fitting tool cover 104a or 104b may have a heating tool used to heat shrink the tool sleeve cover 104a, 104b over the lower half or handle 402 of the tool 102. Accordingly, the tool sleeve cover 104 may be made from heat shrink wrap tubing available commercially. The heat shrink wrap tubing may for example be shrunk quickly to size around the handle 402 of the tool 102 and may be skid proof and offer better gripping as well when the user is holding the handle 402 of the tool 102. In other non-limiting embodiments, a non-heat shrink wrap tubing may alternatively be used to form the tool sleeve cover 104.

Advantageously, the tool sleeve covers 104a, 104b do not impede the regular, ordinary use or purpose of the tool 102. The user does not have to alter the shape or form or structure of the tool 102 to use and/or apply the tool sleeve cover 104, 104b and the tool sleeve cover 104a, 104b does not damage the tool 102. The tool sleeve covers 104a, 104b may be integrally formed from a single section of material to form the tool sleeve covers 104a, 104b in one or more non-limiting embodiments. Alternatively, the tool sleeve covers 104a, 104b may be formed from one or more pieces to make a whole tool sleeve cover 104a, 104b.

There are many other advantages and benefits offered by the one or more non-limiting embodiments of the removable magnetized sleeve 104 as described above.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. A system for a hammer cover sleeve, comprising:
a hammer;
the hammer cover sleeve that is removably attached to a handle of the hammer, wherein the hammer cover sleeve comprises a body having a uniform, single sleeve, wherein the hammer cover sleeve covers at least a portion or all of a handle of the hammer, wherein a longitudinally oriented slit extends down a length of the hammer cover sleeve, wherein the hammer cover sleeve is configured to be tight fitting around the handle of the hammer, and further wherein the hammer cover sleeve comprises an interior cavity that extends therethrough to a closed lower end of the hammer cover sleeve, wherein a bottom end of the hammer is contained inside of the interior cavity of the hammer cover sleeve and above the closed lower end of the hammer cover sleeve; and
at least one magnet, wherein the at least one magnet is configured to fit inside of the hammer cover sleeve,
wherein the at least one magnet is positioned beneath the bottom end of the hammer and above the closed bottom end of the hammer cover sleeve, wherein the at least one magnet is positioned between the bottom end of the hammer and above the closed bottom end of the hammer cover sleeve, such that the bottom end of the hammer touches the at least one magnet, and wherein the closed bottom end of the hammer cover sleeve encloses the at least one magnet, and
wherein the closed bottom end of the hammer cover sleeve is wider than an upper end of the hammer cover sleeve.

2. The system of claim 1, wherein the at least one magnet is a neodymium magnet.

3. (canceled).

4. The system of claim 1, wherein the body of the hammer cover sleeve is generally cylindrical.

5. The system of claim 1, wherein the hammer cover sleeve further comprises a fastener, wherein the fastener functions to fasten the hammer cover sleeve around the handle of the hammer.

6. The system of claim 1, wherein the hammer cover sleeve functions as a handle grip.

7. (canceled).

8. The system of claim 1, wherein the at least one magnet attracts other items to the closed lower end of the hammer cover.

9. (canceled).

10. (canceled).

11. The system of claim 1, wherein the slit is configured to enable the hammer cover sleeve to be placed on the handle of the hammer and removed from the hammer cover sleeve to add additional magnets to increase magnetic attraction.
